(19) United States
(12) Patent Application Publication
(10) Pub. No.: US 2014/0032394 A1
(43) Pub. Date: Jan. 30, 2014

(54) PEER TO PEER LENDING USING A MOBILE WALLET

(71) Applicant: Mozido, LLC, Austin, TX (US)

(72) Inventors: Michael A. Liberty, Windermere, FL (US); Steve Bacastow, CUMMING, GA (US)

(73) Assignee: Mozido, LLC, Austin, TX (US)

(21) Appl. No.: 13/951,194

(22) Filed: Jul. 25, 2013

Related U.S. Application Data
(60) Provisional application No. 61/676,076, filed on Jul. 26, 2012.

(51) Int. Cl. G06Q 40/02

(52) U.S. Cl. CPC G06Q 40/025
USPC 705/38

(57) ABSTRACT

An electronic payment system for peer to peer money lending can receive a lending request from a lendee. The lending request can indicate a requested amount of money. The system can open a loan ticket corresponding to the lendee. The system can then receive the lending amount from one or more lenders indicating the amount the lender intends to lend to the lendee. Once the system determines that the loan ticket amount has been filled, the system can provide the loan ticket amount to the lendee.

### CROSS-REFERENCE TO RELATED APPLICATIONS

This application claims priority to and the benefit of U.S. Provisional Application Ser. No. 61/676,076, entitled “Peer to Peer Lending Using a Mobile Wallet”, filed on Jul. 26, 2012, which application is incorporated by reference herein in its entirety.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

Today's smart phones use software applications to perform a wide variety of functionality. In some cases, this functionality may include the ability to pay for items using a mobile payment system. Such a mobile payment system may allow users to pay for items at a store or over the Internet using their phone. Other systems may facilitate more advanced financial services using a mobile device such as stock trading, bill payment or lending.

### BRIEF SUMMARY

Embodiments described herein are directed to an electronic payment system for peer to peer money lending. The system can receive a lending request from a lendee. The lending request can indicate a requested amount of money. The system can open a loan ticket corresponding to the lendee. The system can then receive the lending amount from one or more lenders indicating the amount the lender intends to lend to the lendee. Once the system determines that the loan ticket amount has been filled, the system can provide the loan ticket amount to the lendee.

Additionally, in some embodiments, the system can receive a lending request from a lendee. The lending request can indicate a requested amount of money. The system can then create a loan ticket corresponding to the lendee. Additionally, the system can receive a proposed interest rate from a lender indicating the amount of interest that the lender suggests should be applied to a loan for the requested amount of money. In response, the system can receive a counter-proposed interest rate from the lendee indicating the amount of interest that the lendee suggests should be applied to the loan. Eventually, the system can receive an indication of a mutually agreed upon interest rate from both the lender and the lendee. The system can then provide the loan ticket amount to the lendee, wherein the mutually agreed upon interest rate is applied to the loan.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### DETAILED DESCRIPTION

Embodiments of the present invention extend to methods, systems, and computer program products for lending money in a peer to peer manner. Money lenders can contribute various amounts of money to different loan tickets. Each loan ticket corresponds to a specified lendee who promises to pay back the money loaned to them by the lenders. Using this mechanism, the lendor assumes a risk that they may lose their money in exchange for a return on investment in the form of an interest payment. Embodiments that facilitate such peer to peer money transfers will be described herein below.

In some embodiments, an electronic money transfer system may be instantiated which facilitates money transfer from one or more lenders to one or more lendees. In most cases, multiple lenders will combine to fulfill a loan ticket to a single lendee. The electronic money transfer system may offer a loan ticket electronically in one of a variety of different interfaces including a web page, a mobile phone application, a tablet application, a telephone menu system or any other interface that allows potential lenders to view available loan tickets and/or potential lendees.

Each lendee may have his or her own lending profile. The profile may include a ranking or other measurement system that indicates the lendee's ability or propensity to repay the loan. For example, the profile may indicate the repayment history for any previous loan tickets. Alternatively, the profile may provide banking information, credit scores, mortgage/rent payment history, utility bill history or other indications of the user's willingness and ability to repay a loan or other bill. Still further, the profile may indicate that the lendee has posted collateral such as a paycheck stub, car title or other item of value. Personal information including name, address, employer name and address, phone number and other public and/or private information may also be included in the lendee's profile.

Lenders may also have profiles with similar information. The lenders may provide bank account information or may provide other sources for the money that is to be loaned. The lender may be able to browse through lendee profiles and choose one or more loan tickets to which the lender would like to contribute. The lender may select a loan ticket (e.g. for a total amount of $500) and indicate that he or she wishes to apply $100 toward the loan ticket. Once other lenders have agreed to provide the remaining amount ($400 in this case), the loan ticket will be fulfilled and the electronic money transfer system will transfer the loan amount (i.e. $500) to the lendee. System may be configured to require the full amount of the loan ticket to be funded before making deposits available to the lendee. Alternatively, the system may be configured to allow amounts deposited by lenders to be made immediately available through a configuration setting.

The money may be transferred through a bank or credit union to the lendee's account, or may be transferred directly to a lendee's mobile wallet. The mobile wallet may be wirelessly connected to the electronic money transfer system, and may provide an interface for the lendee to access his or her money, and may provide an interface for the lender to select loan tickets and transfer money to the lendee.

In cases where either or both of the lendee and the lender have a mobile wallet, the lendee or lender also has a corresponding account with access to the electronic money transfer or mobile payment system. The mobile payment system can provide the lender/lendee (i.e. the user) with a variety of functionality including purchasing items along with one or more of depositing funds, withdrawing funds, transferring funds, etc. Accordingly, the user can use a digital device (e.g., a computer or mobile phone) to interact with the electronic payment system to transfer money and/or pay for goods and services. This mobile payment system may be referred to herein as a “mobile wallet” or “mobile wallet application”.

For example, a user may use a mobile wallet to pay for an item at a retail goods store. The mobile wallet may communicate with a retailer's payment system and pay for the goods or services from the user's bank account or credit card account linked to the user's mobile wallet. The mobile wallet may also perform many other functions in addition to purchasing goods and borrowing or lending money.

In some embodiments, a client application for the electronic payment system (e.g. the mobile wallet) runs on the user's digital device. The user interacts with the electronic payment system through the client application. From a screen of the client application, the user can search for loan tickets, select a ticket and loan money using the application, or, as a lendee, provide a loan ticket requesting money.

Embodiments of the invention include mobile telephones, tablets or other digital devices interoperating with an electronic money transfer or payment system, such as, for example, a mobile wallet, to purchase goods and/or services.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, special purpose processing device, to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones (having various different capabilities and features), PDAs, pagers, routers, switches, and the like. Embodiments of the invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

An electronic money transfer and payment system architecture can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

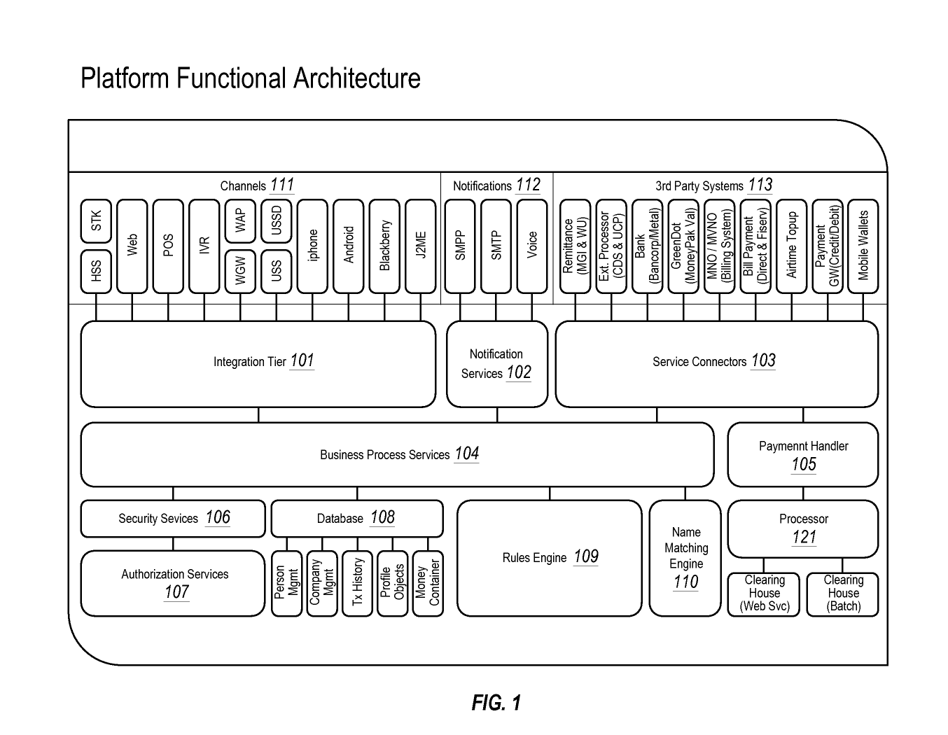

FIG. 1 illustrates an example system architecture for an electronic money transfer and payment system. Integration tier 101 is configured to manage sessions and maintain integrity of financial transactions. Integration tier 101 can also include a communication (e.g., Web services) API and/or other communication mechanisms to accept messages from channels 111. Other mechanisms include, but are not limited to: International Standards Organization (“ISO”) 8583 for Point of Sale (“POS”) and Automated Teller Machines (“ATM”) devices and Advanced Message Queuing Protocol (“AMQP”) for queue based interfaces. Each of channels 111 can be integrated to one or more mechanisms for sending messages to integration tier 101. Notification services 102 is configured to send various notifications through different notification channels 112, such as, for example, Short Message Peer to peer (“SSMP”) for Short Messaging Service (“SMS”) and Simple Mail Transfer Protocol (“SMTP”) for emails. Notification services 102 can be configured through a Web services API.

Service connectors 103 are a set of connectors configured to connect to 3rd party systems 113. Each connector can be a separate module intended to integrate an external service to the system architecture. Business process services 104 are configured to implement business workflows, including executing financial transactions, auditing financial transactions, invoking third-party services, handling errors, and logging platform objects. Payment handler 105 is configured to wrap APIs of different payment processors, such as, for example, banking accounts, credit/debit cards or processor 121. Payment handler 105 exposes a common API to facilitate interactions with payment processors. Security services 106 are configured to perform client authentication. Authorization services 107 are configured to perform client authorization, such as, for example, using a database-based Access Control List (“ACL”) table.

Database 108 is configured to manage customer accounts (e.g., storing customer accounts and properties), manage company accounts (e.g., storing company accounts and properties), manage transaction histories (e.g., storing financial transaction details, loan repayment details, etc.), store lender/lendee profiles, store dictionaries used by the electronic money transfer and payment system, such as, for example, countries, currencies, etc., and manage money containers. Rules engine 109 is configured to gather financial transaction statistics and uses the statistics to provide transaction properties, such as, for example, fees and bonuses. Rules engine 109 is also configured to enforce business constraints, such as, for example, transactions and platform license constraints.

Name matching engine 110 is configured to match different objects according to specified configuration rules. Name Matching engine 110 can be used to find similarities between names, addresses, etc. Processor 121 is configured to manage financial accounts and transactions. Processor 121 can be used to hold, load, withdraw and deposit money to mobile wallet accounts. Processor 121 can also be used as a common interface to a third party processor system. When used as a common interface, financial operations are delegated to the external processor. A Clearing House subsystem of processor 121 can be used to exchange the financial information with a bank.

Components of an electronic payment system can be connected to one another over (or be part of) a system bus and/or a network. Networks can include a Local Area Network (“LAN”), a Wide Area Network (“WAN”), and even the Internet. Accordingly, components of the electronic payment system can be “in the cloud”. As such, electronic payment system components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the system bus and/or network.

The components depicted in FIG. 1 can interoperate to provide a number of financial and other services including but not limited to enrolling a customer for a mobile wallet, adding a stored value account (either hosted by an electronic payment system or a third party), adding a bank/credit union account to a mobile wallet, adding a debit/credit card account to a mobile wallet, depositing money and/or monetary rewards in a mobile wallet, withdrawing funds from a mobile wallet, paying bills from a mobile wallet, topping up a prepaid mobile account through a mobile wallet, transferring funds through a mobile wallet, making in-store purchases from a mobile wallet, transferring money to a loan ticket and receiving money from a fulfilled loan ticket.

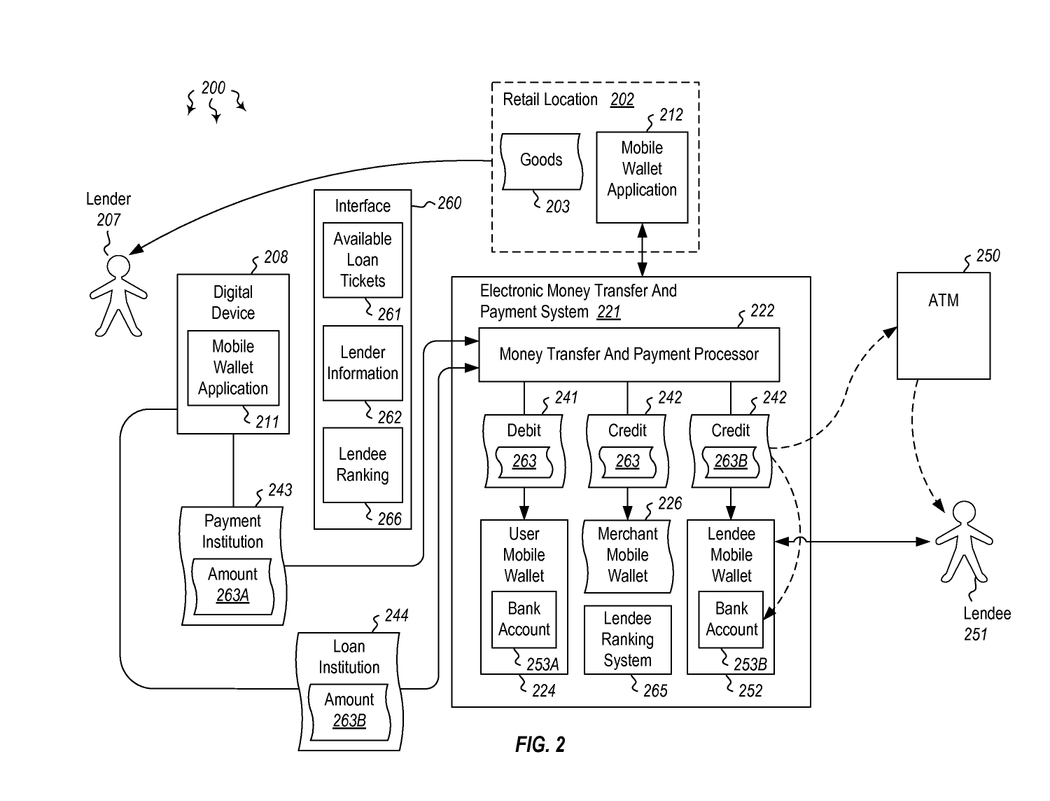

FIG. 2 depicts a computer system architecture 200 for performing any one or more of the above functions, including providing peer to peer lending where at least one lender applies money to a loan ticket which, when fulfilled is then given to the lendee as a loan.

As depicted in FIG. 2, computer architecture 200 includes digital device 208, retail location 202, and electronic money transfer and payment system 221. Digital device 208 further includes mobile wallet application 211. Retail location 202 further includes its own mobile wallet application 212. Electronic money transfer and payment system 221 further includes money transfer and payment processor 222, user mobile wallet 224 (lender 207's mobile wallet), merchant mobile wallet 226 (retail location 202's mobile wallet), the lendee's mobile wallet 252 and other items.

FIG. 2 depicts three different parties: a money lender (207), a retailer 202 and a lendee 251. The lender 207 may use the mobile wallet application 211 of his or her mobile device 208 to perform multiple functions including lending money as well as purchasing products (e.g. 203 from a retail location 202). The lender may determine which loan ticket 261 to choose by looking at the loan ticket's associated lendee information 262. Each loan ticket includes information about the corresponding lendee. The information may include personal information about the lendee, information about past loans, payback rates, interest rates paid, number of on-time and late payments, credit score or a different credit ranking generated by the electronic money transfer and payment system 221. The lender may use this information to determine how much risk he or she is willing to take. Lendees that have never borrowed money before, or have been late on other payments, may be a higher risk. Such lendees may also be subject to higher interest rates. Correspondingly, if a lendee has a high credit ranking, that lendee may be a lower risk and may be entitled to lower interest rates.

The electronic money transfer and payment system 221 can be configured to work with a variety of different lender/lendee configurations. For example, a business can act as a lendee 251 in requesting a loan from another business acting as a lender 207. Additionally, a business can act as a lendee 251 receiving a loan from an individual acting as a lender 207. Similarly, an individual can act as a lendee 251 and receive a loan from a business lender 207. Also, an individual lendee 251 can receive a loan from an individual lender 251.

In some embodiments, a lendee ranking or scoring system 265 may be provided. For example, each lendee may be ranked according to a variety of different factors including credit score, bill payment history, employer references or other indications of credibility. Each factor may be weighted according to a weighting system that places emphasis on certain factors. In some cases, different lenders may set up their own lendee ranking system. In such cases, the lendee may submit required information and the lender's ranking system would rank the lendee accordingly. As such, many different lendee ranking systems may be implemented. Each lender can subscribe to their ranking system of choice.

Additionally, in at least one embodiment, the lendee ranking or scoring system 265 can also analyze and incorporate into a user's ranking information from a user's social media accounts, criminal and driving records, current and pending lawsuits, actual credit score, and other publicly available information. For example, regarding social media accounts, in at least one embodiment a user's social media friends and association can be analyzed and used to influence a user's ranking Similarly, postings that a user makes to social media can also be analyzed and used to influence a user's ranking For example, particular types of identifiable negative postings may lower a user's ranking Further, as mentioned, a user with a significant number of speeding tickets may be assigned a lower ranking Relying upon a user's social media presence, driving record, and other publicly available information may be particularly useful when determining the ranking of a user that does not belong to a bank and may not otherwise have a credit score.

A lendee's ranking can be continually or periodically updated based upon new information. In some embodiments, a lendee's ranking can influence the interest rate of future and current loans. For example, if a lendee's ranking rises the lendee's interest rate for particular loans can go down. In contrast, if the lendee's 251 ranking sinks the lendee's interest rate can rise or a loan can even be revoked. For instance, a lender 207 may stipulate in a loan that if the lendee's ranking drops below a certain level the loan immediately comes due. Similarly, a lender 207 can be automatically notified when a lendee's ranking changes, for better or for worse, and be informed about the reason for the change.

Lenders may then use the lendee ranking 266 to make decisions on whom to lend money to. The lendees may be filtered based on certain criteria including lendee ranking, payment history, employer references or any of a variety of different factors. Lenders may also be able to search for lendees based on specific qualifications, including employment history, bill payment history or any other of the above factors. In some cases, a lender may be able to search for lendees and view the profiles of each lendee that is returned in the search results. The lender can then filter the lendees and the lendees' corresponding loan tickets based on these factors. Additionally, the lender can filter and search for particular loans by interest rate. Once the list of lendees has been filtered, the lender can allocate loan amounts to different selected lendees across the search results. The lender can lend as much or as little as they want to each lendee.

Interface 260 may present the various lendees and their available loan tickets 261. The interface may be presented as a web application displayable on a browser, as a mobile application, as part of mobile wallet 211, as part of a phone menu system or any other interface that shows or explains which loan tickets are available. The loan tickets may be for substantially any amount, and may be divided between substantially any number of lenders 207. Each lender may bid the amount 263B he or she desires as indicated in loan instruction 244. As lender bids are received at the electronic money transfer and payment system 221, available loan tickets are fulfilled and the money is transferred to the lendee 251.

Lenders 207 and/or lendees 251 can also participate together in a bidding system. For example, a lender 207 can identify a particular lendee 251 to whom the lender 207 wishes to lend money. The lender 207 can then choose to lend the entire requested amount, or only a portion of the amount. In some embodiments, if the lender 207 decides to only lend a portion of the amount, then the money will be provided to the lendee 251 after other lenders 207 have agreed to provide the remaining money to the lendee. Additionally, in some embodiments, if multiple lenders attempt to fund a loan then whichever lender first selected the loan will be allowed to fund it.

In addition, in some embodiments, the lendee 251 can select from a group of lenders 207 which lender will provide the money for a desired loan. For example, several different lenders 207 may be interested in lending money to a lendee 251 with a particularly good ranking. In this case, a lendee 251 can select an individual lender to provide the entire requested amount, or the lendee 251 can select multiple lenders 207 to provide the money. In at least one embodiment, the lendee 251 can determine what proportion of the total amount each individual lender provides 207.

In some embodiments, in addition to bidding on various loan arrangements, a lender 207 and a lendee 251 can barter over an agreeable interest rate. For example, a lender 207 may be willing to provide a lendee 251 with a particular loan amount, but only at a specific interest rate. A lender 207 can communicate this specific interest rate to a lendee 251 who has the choice of accepting the rate, rejecting the rate, or proposing a different rate. In this way, lendees 251 with high rankings may be able to negotiate low interest rates, while lenders 207 with high ratings may be able to negotiate high interest rates.

Similarly, in some embodiments, a lender 207 can signify through the interface 260 that the lender is willing to loan a particular amount of money at a particular rate to any qualifying lendee 251. For example, a lender 207 may be interested in loaning money at a specific interest rate to any lendee 251 that is ranked at or above a certain level. Accordingly, the interface 260 can provide a multitude of potential lendees 251 the option of accepting the lenders 207 money at the proffered rate.

In contrast to being able to barter interest rates, in some embodiments interest rates are set based upon lendee ranking and other market factors. In some cases, a combination of the above recited methods for determining interest rates may be available. For example, a lendee 251 may be able to pursue a fixed interest rate determined by the lendee's ranking, while in other cases the lendee may be able to pursue a bartered interest rate that was is negotiated between the lendee 251 and the lender 207. In any of the above examples the interest rate can be adjustable based upon changes in the lendee's ranking

The money may be transferred to the lendee in a variety of different manners. For instance, the money may be transferred as a credit 263B to the lendee's mobile wallet 252. The money may be transferred to one or more accounts associated with the mobile wallet 252 including bank account 253B, to a credit or debit card or to another type of financial account. Alternatively, the money may be transferred directly to the lendee's bank or other account without transferring it to the lendee's mobile wallet. Still further, the money may be wired directly to an establishment that provides money wires. The money may also be made available to the lendee via an ATM 250. Accordingly, the money may be distributed from the one or more lenders to the electronic money transfer and payment system 221, and then to the lendee in any of the above manners.

The lendee may then pay back the money using his or her mobile wallet 252 or other account that can transfer money to the money transfer and payment system. The money transfer system then transfers the money back to the lenders (in some cases equally to each lender, such that each lender gets the same portion of the repaid money, and in some cases proportionally, such that lenders that provided a larger share of the loan receive a larger share of the repaid money, and lenders that provided a smaller share receive a smaller share of the repaid money). The money may be transferred back to the lenders via a mobile wallet, or via a bank or other financial account.

Thus, over time, lenders and lendees will build up reputations as being reliable payors and payees. The electronic money transfer and payment system 221 keeps track of each transaction and increases or decreases each user's ranking based on whether the money was successfully transferred and successfully repaid. If the lendee fails to pay back the loan in a timely manner, or forfeits on the loan, the failure to repay may be reported to known credit agencies. The user's ranking may be displayed next to each loan ticket in a manner that is easy to understand such as a number of stars (e.g. 3 out of 5 stars) or other numerical indicator (e.g. a scale of 1 to 10 where 10 indicates a high level of credibility). Various portions of the lendee's personal information may also be displayed alongside the ranking All this information may help potential lenders to make an informed decision on whom to lend money to.

In some embodiments, a lendee may be pre-approved for a certain amount of credit (e.g. by going through a loan pre-approval process). The amount of credit may be attached to a blank loan ticket. As such, a lendee can request a loan for the amount specified in the pre-approval. Using the blank loan ticket, the lendee can use the borrowed money to purchases goods or services, similar to purchasing goods or services using a credit card. Funds would transfer from the lender to the lendee as lendee spends the money. Interest charges would begin to accrue at the time the lendee first spends the money. Lendees may be pre-approved by various entities including credit agencies and lenders.

As mentioned above, lenders may also use the mobile wallet application 211 to purchase goods from various retail locations. Each entity (the lender 207, the retail location 202, and the lendee 251) is connected to electronic money transfer and payment system 221. Each entity may have their own mobile wallet, or may have other access to the electronic payment system (e.g. through a bank or an ATM). The user may use the mobile wallet 224 to pay for the retailer's goods 203. The retailer's mobile wallet 226 may be provided by a mobile wallet application 212. The retailer's mobile wallet allows users to pay for the retailer's goods using their own mobile wallets.

When paying for goods 203, mobile wallet application 211 can send payment instruction 243 in amount 263A to electronic money transfer and payment system 221. Payment processor 222 can receive payment instruction 243. In response, payment processor 222 can debit 241 user mobile wallet 224 by amount 263. Payment processor 222 can also credit 242 merchant mobile wallet 226 by amount 263.

Although not depicted, various other modules from the architecture of FIG. 1 can also be included electronic payment system 221. The modules expressly depicted in FIG. 2 can interoperate with these other modules as appropriate to facilitate desired functionality.

The functionality of the mobile wallet may be provided to a user regardless of whether the user has a bank account. The mobile wallet may be used to view available loan tickets, bid on loan tickets and receive payments from lendees. Moreover, the mobile wallet may be used to submit loan tickets by a lendee and receive money from the lenders. The mobile wallet may be used on prepaid phones or pay-as-you-go phone plans. Accordingly, a user may use the mobile wallet and the electronic money transfer and payment system with a prepaid (or other) phone and without a bank account. The mobile wallet may be used with any type of currency, and any existing money may be adjusted for value based on the current location of the user.

Embodiments of the invention can adhere to Know Your Customer (KYC) rules in the US by performing Customer Identification Program (CIP) checks as required by the Bank Secrecy Act and US PATRIOT Act. A minimum amount of information can be gathered about a customer, such as, for example, First Name, Last Name, Date of Birth, Government ID Type, Government ID Number, and Address. The CIP processes are designed to validate customer identity against government blacklists and assists in the prevention of money laundering and terrorist financing. A combination of non-documentary and documentary verification can be used to ensure beyond a reasonable doubt the identity of the customer.

Non-Documentary Verification can occur through the presentment of the information that was collected from the user to an external third party, such as, for example, Lexis Nexis. Documentary Verification can occur if non-documentary verification fails, then the user is asked to present an unexpired government ID. Various differ forms of identification including Driver's license, Passport, Alien identification (e.g., green card or work visa), and Mexican Consular identification card, can be accepted.

Embodiments of the invention can perform Anti-Money Laundering (AML) and Combating the Financing of Terrorism (CFT) checks. AML and CFT checks can be performed using transaction monitoring methods to flag names and suspicious transactions for further investigation. The electronic payment system can perform AML and CFT checks on all electronic financial transactions to ensure that electronic funds are not being used for money laundering or terrorism. Transaction limits can be placed on user accounts. The transaction limits are fully configurable for each particular use case, channel and payment method that allows maximum flexibility to restrict higher risk use cases. Velocity checks can also be performed. Velocity Checks ensure that subscribers are not abusing the electronic payment system within the allowable limits.

In at least one embodiment, the invention can also screen lendee and lender identities to identify individuals and organizations that have been placed on watch lists. The screenings can occur at the time of registration, at the time a loan is official pursued, or on a continual or periodic basis. If a particular individual fails to pass a screening the invention can notify a system administrator, notify law enforcement, or notify some other identified individual.

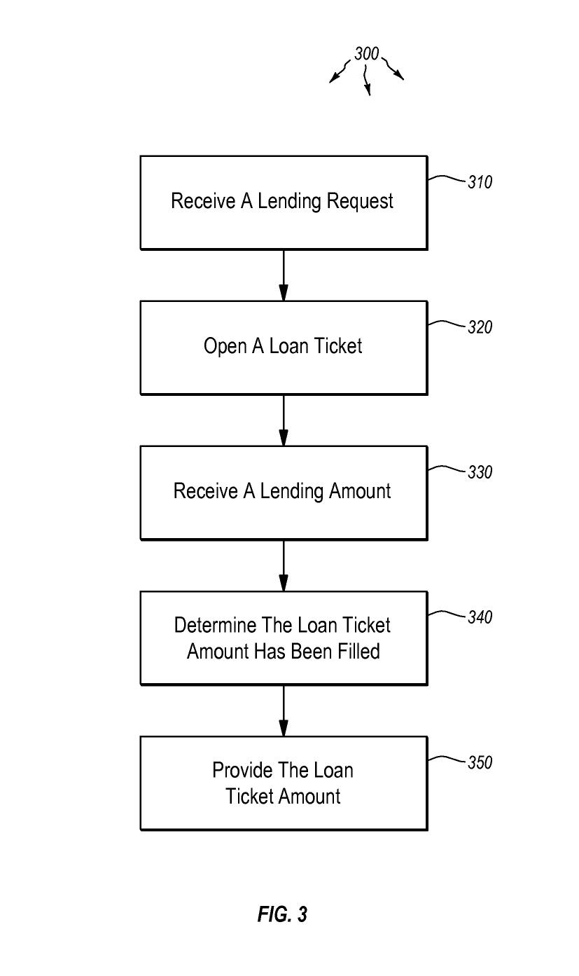

In one embodiment, as described in FIG. 3, a method 300 is provided for establishing a peer to peer lending system. Method 300 includes an act of receiving a lending request from a lendee, the lending request indicating a requested amount of money (act 310). In response, the electronic money transfer and payment system 221 can open a loan ticket corresponding to the lendee, the lending ticket allowing one or more lenders to provide money for the loan ticket (act 320). The electronic money transfer and payment system 221 can then receive a lending amount from one or more lenders indicating the amount the lender intends to lend to the lendee (act 330). After receiving a lending amount from one or more lenders, the electronic money transfer and payment system 221 can determine that the loan ticket amount has been filled (act 340). The electronic money transfer and payment system 221 can then provide the loan ticket amount to the lendee (act 350).

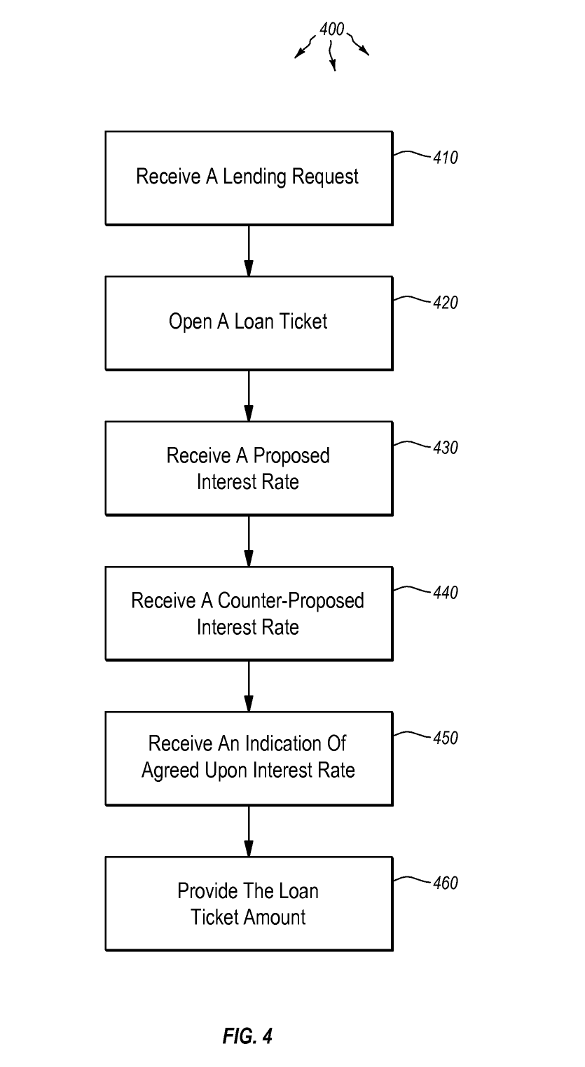

In another embodiment, as described in FIG. 4, a method 400 is provided for establishing a peer to peer lending system. Method 400 includes an act of receiving a lending request from a lendee, the lending request indicating a requested amount of money (act 410). In response, the electronic money transfer and payment system 221 may open a loan ticket corresponding to the lendee, the lending ticket allowing one or more lenders to provide money for the loan ticket (act 420). The electronic money transfer and payment system 221 can then receive a proposed interest rate from a lender indicating the amount of interest that the lender suggests should be applied to a loan for the requested amount of money (act 430). After receiving a proposed interest rate, the money transfer and payment system 221 can receive a counter-proposed interest rate from the lendee indicating the amount of interest that the lendee suggests should be applied to the loan (act 440). The electronic money transfer and payment system 221 can then receive an indication of a mutually agreed upon interest rate from both the lender and the lendee (act 450). Based upon the mutually agreed upon interest rate, the electronic money transfer and payment system 221 can provide the loan ticket amount to the lendee (act 460).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a electronic payment system including one or more processors and system memory, a method for peer to peer money lending, the method comprising:
an act of receiving a lending request from a lendee, the lending request indicating a requested amount of money;
an act of opening a loan ticket corresponding to the lendee, the loan ticket allowing one or more lenders to provide money for the loan ticket;
an act of receiving a lending amount from one or more lenders indicating the amount the lender intends to lend to the lendee;
an act of determining that the loan ticket amount has been filled; and
an act of providing a loan of the loan ticket amount to the lendee.

2. The method of claim 1, further comprising an act of displaying a lending ranking associated with the lendee.

3. The method of claim 2, wherein the lendee's lending ranking is determined by an analysis of the lendee's criminal and driving records.

4. The method of claim 2, wherein the lendee's lending ranking is determined by an analysis of information from a user's social media accounts.

5. The method of claim 2, wherein an interest rate associated with the loan ticket is related to the lendee's lending ranking

6. The method of claim 5, wherein the lendee's lending ranking is at least periodically updated.

7. The method of claim 6, wherein the interest rate associated with the loan ticket can be adjusted during a life of the loan based upon the updated lendee's lending ranking

8. The method of claim 6, further comprising the act of notifying the one or more lenders when a change occurs to the lendee's lending ranking

9. The method of claim 1, wherein the lendee applies for the loan ticket via at least one of a telephone, the Internet, a kiosk, and an ATM.

10. At an electronic payment system including one or more processors and system memory, a method for peer to peer money lending, the method comprising:
an act of receiving a lending request from a lendee, the lending request indicating a requested amount of money;
an act of opening a loan ticket corresponding to the lendee, the loan ticket allowing one or more lenders to provide money for the loan ticket;
an act of receiving a proposed interest rate from a lender indicating the amount of interest that the lender suggests should be applied to a loan for the requested amount of money;
an act of receiving a counter-proposed interest rate from the lendee indicating the amount of interest that the lendee suggests should be applied to the loan;
an act of receiving an indication of a mutually agreed upon interest rate from both the lender and the lendee; and
an act of providing the loan ticket amount to the lendee, wherein the mutually agreed upon interest rate is applied to the loan.

11. The method of claim 10, further comprising an act of determining a lending ranking associated with the lendee.

12. The method of claim 11, wherein the lendee's lending ranking is determined by an analysis of the lendee's criminal and driving records.

13. The method of claim 12, wherein the lendee's lending ranking is determined by an analysis of information from a user's social media accounts.

14. The method of claim 11, wherein the lendee's lending ranking impacts the interest rate that is applied to the loan.

15. The method of claim 14, wherein the lendee's lending ranking is at least periodically updated.

16. The method of claim 15, wherein the interest rate associated with the loan can be adjusted during a life of the loan based upon the updated lendee's lending ranking

17. The method of claim 15, further comprising the act of notifying the one or more lenders when a change occurs to the lendee's lending ranking

18. The method of claim 10, wherein available loan tickets are displayed in an interface including at least one of a web interface, a mobile device application and a mobile wallet.

19. The method of claim 10, wherein the lendee applies for the loan ticket via at least one of a telephone, the Internet, a kiosk and an ATM.

20. A peer to peer lending system comprising the following:
one or more processors;
system memory;
one or more computer-readable storage media having stored thereon computer-executable instructions that, when executed by the one or more processors, cause the computing system to perform a method for executing a peer to peer lending system, the method comprising the following:
an act of registering a lendee and a lendor for the purpose of conducting business using a peer-to-peer lending system;
an act of receiving a lending request from a lendee, the lending request indicating a requested amount of money;
an act of opening a loan ticket corresponding to the lendee, the loan ticket allowing one or more lenders to provide money for the loan ticket;
an act of receiving a lending amount from one or more lenders indicating the amount the lender intends to lend to the lendee;
an act of determining that the loan ticket amount has been filled; and
an act of providing a loan of the loan ticket amount to the lendee.

21. The system of claim 20, further comprising collecting specific data about both the lendee and the lendor during the registration process.

22. The system of claim 21, further comprising comparing the collected specific data about both the lendee and the lendor to information stored in one or more published watch list databases.

23. The system of 22, further comprising:
identifying a positive match between the collected specific data and the information stored in the one or more published watch list database; and
terminating the registration act.
